(19) United States
(12) Patent Application Publication
(10) Pub. No.: US 2017/0050282 A1
(43) Pub. Date: Feb. 23, 2017

(54) Robot cell for loading and unloading single-station machining units in concurrent operation time

(71) Applicant: SK-Technologies UG, Aichhalden (DE)

(72) Inventor: Stefan Andreas Kruck, Aichhalden (DE)

(73) Assignee: SK-Technologies UG, Aichhalden (DE)

(21) Appl. No.: 15/120,054

(22) PCT Filed: Feb. 18, 2015
(86) PCT No.: PCT/EP2015/053445

§ 371 Date: Aug. 18, 2016

(30) Foreign Application Priority Data
Feb. 21, 2014 (DE) 20 2014 001 487.6
Mar. 4, 2014 (DE) 10 2014 002 746.5
Mar. 17, 2014 (DE) 10 2014 003 596.4
Mar. 18, 2014 (DE) 10 2014 003 720.7
May 27, 2014 (DE) 10 2014 007 654.7
Jul. 26, 2014 (DE) 10 2014 010 880.5
Jul. 28, 2014 (DE) 10 2014 010 925.9
Sep. 30, 2014 (DE) 10 2014 114 258.6
Nov. 25, 2014 (DE) 10 2014 017 343.7
Dec. 5, 2014 (DE) 10 2014 017 930.3

(51) Int. Cl. B23Q 7/04; B23Q 11/08; B25J 21/00; B23Q 3/06

(52) U.S. Cl. CPC B23Q 7/04; B23Q 3/061; B23Q 11/0891; B25J 21/00

(57) ABSTRACT

Robot cell with a robot cell chamber for loading and unloading single-station machine tools and with a machine chamber, wherein at least one robot is arranged in the robot cell chamber and wherein at least two clamping points and at least one machining spindle of a single-station machine tool are arranged in the machine chamber, and so the clamping points for receiving workpieces in the machine chamber can be reached by the robot, wherein the robot cell chamber can be coupled to the machine chamber such that a machining chamber is formed in the state in which the robot cell chamber is coupled to the machine chamber, and a device for machining, wherein the device has a robot cell and a single-station machine tool.

The invention relates to a robot cell for loading and unloading single-station machining units according to the preamble of claim 1, and a device for machining according to claim 21.

These types of systems are known in principle in various forms, and are used primarily in conjunction with CNC-controlled machines.

In the present and following discussions, the term “robot cell” refers to a separate, dedicated unit. In contrast, in fixed systems, single robots are rigidly connected to a machine tool or anchored to the floor. These fixed systems have often proven to be inflexible, and require additional safety equipment.

In the present and following discussions, “operation time” refers to the machining time for workpieces. During loading and unloading in concurrent operation time (also called “operation time-neutral”), these loading and unloading operations have no effect on the machining time for the workpieces. In the present and following discussions, the term “loading and unloading chamber” refers to a separate, segregated space for loading and unloading workpieces into/out of the clamping points.

In the present and following discussions, the term “single-station machine” refers to a machine tool in which the machining spindles are fixedly associated with a holder (a machine table, for example) which bears a workpiece. Thus, the holder (a machine table or additional axis, for example) bearing the workpiece is not transferred from one machining point to the next, or from the machining point to the loading and unloading chamber.

The machining spindle is preferably used for machining. Milling, drilling, thread cutting, grinding, polishing, lapping, and honing are mentioned as primary applications in common machining methods.

Two different concepts are known in the prior art for loading and unloading machining units in concurrent operation time. The first concept is machining on exchange station machines, in which the machining chamber is separated from the loading and unloading chamber (also referred to as the placement chamber) by a wall. The second concept is transfer machines, in which multiple machining stations are arranged according to a rotary transfer principle, for example. Here as well, loading and unloading chambers are separate from one another.

In such concepts, depending on the machine design, changing the workpiece from the placement station to the machining station takes a period of several seconds, which does not elapse in concurrent operation time; i.e., as non-productive time it extends the overall time and ultimately makes the workpiece more expensive.

Both concepts share the common feature that the actual clamping time of workpieces does not have to be added to the actual operation time, since the clamping of workpieces takes place in the placement chamber, while machining is carried out in the machining chamber. Thus, the clamping of the workpieces takes place in concurrent operation time, provided that the clamping time is shorter than the machining time. Only the changing of the clamping point from the placement chamber to the machining chamber does not take place in concurrent operation time.

Disadvantages of these two machine concepts are very high machine capital costs, additional time for changing the workpiece from the placement station to the machining station during each machining cycle, and appropriate rotary passages for media of the clamping means, such as oil for hydraulic clamping at the clamping points. In particular, exchange station machines have a rotary table, which is a drawback with regard to technical complexity. In addition, exchange station machines require a large amount of room on account of a rotary table, which may result in space problems. Furthermore, these types of machines require a relatively large quantity of energy due to the rotary movements that occur.

The invention is based on the problem that known robot cells are designed in such a way that in such machines, the robot cannot reach into the machine space during the machining time. In that case, the use of multiple clamping points is often not very meaningful, since the loading and unloading of these additional clamping points does not take place in concurrent operation time and lasts too long. The machine space is usually completely closed in order to separate the robot cell chamber from the machining chamber. The access between the robot cell chamber and the machining chamber does not become open until after the end of machining. Only then can the loading and unloading of the clamping points take place.

The object of the invention, therefore, is to provide a robot cell for loading and unloading single-station machining units in concurrent operation time, and a device for machining without exchange station operations and without transfer operations, in which, apart from a relatively very short travel time of a machine table from one clamping position to the next, in each case no additional time results from changing the workpiece from the placement station to the machining station during each machining cycle.

The object of the invention is achieved by a robot cell for loading and unloading single-station machining units in concurrent operation time, having the features of claim 1, and a device for machining having the features of claim 21.

Advantageous embodiments and refinements of the invention are set forth in the subclaims.

The robot cell according to the invention, having a robot cell chamber for loading and unloading single-station machining units, and having a machine space, at least one robot being situated in the robot cell chamber, and at least two clamping points and at least one machining spindle of a single-station machining unit being situated in the machine space, so that the clamping points for receiving workpieces in the machine space can be reached by the robot, is characterized in that the robot cell chamber is coupleable to the machine space in such a way that a machining chamber is formed in the coupled state of the robot cell chamber and the machine space. By using multiple clamping points, it is also possible to machine various workpieces concurrently, simply by equipping the various clamping points with different workpiece clamping means. The invention thus allows a number of different workpieces to be machined during one complete machining pass. With the functionality of coupleability, the single-station machining unit may be manually loaded. When the robot cell chamber is decoupled, it is relatively easy to set up the machine space with workpieces. “Manual operation” means operation by means of human intervention. Due to coupling the robot cell, the single-station machining unit may be automatically supplied in so-called automatic operation. A robot cell with continuous automatic operation has proven advantageous when repair or maintenance operations must be performed in the machine area, in which case the robot cell may be easily decoupled. In such cases, a “fixed system” often has little or no accessibility. The robot cell provides protection against hazardous entry or access.

The robot cell is preferably detachably coupleable to the single-station machining units. The robot cell may be easily decoupled in the machine area for repair or maintenance operations. In such cases, a “fixed system” often has little or no accessibility.

A coupling site of the robot cell advantageously has a coupling site seal between the robot cell chamber and the machine space on the single-station machining unit. The coupling site seal forms a connection of the robot cell to the machine. The machine space is thus combined with the robot cell chamber. There is no separate loading and unloading chamber, as is the case for exchange station machines or transfer machines, and instead there are only loading and unloading positions. In the present and following discussions, the loading and unloading position is understood to mean the position of the loading and unloading, independently of the chamber. If the coupling site to the machine is designed with a coupling site seal, escape of machining auxiliary materials, other media, and cutting chips may advantageously be avoided.

According to one preferred embodiment of the invention, the single-station machining unit is loadable and unloadable by the robot in concurrent operation time, preferably in an automated manner. When operation is carried out in concurrent operation time, workpieces may be machined in the machine tool, and new workpieces may be supplied at the same time. This supplying may take place directly or by means of workpiece carriers.

In one refinement of the invention, the robot cell is suitably designed so that the clamping points for receiving the workpiece in the machine space are reachable by the robot when the machining spindle is idle and/or running. For a running machining spindle, spindle stoppages, which in exchange station machines are necessary for an appropriate station change, are dispensed with.

In another embodiment of the invention, the robot cell has control means. Via control means, the clamping points may be controlled, and clamping of supplied workpieces by the robot cell may be triggered. During automatic operation, the clamping points may thus be automatically clamped in a continuous cycle.

The control means are preferably suitably designed in such a way that the clamping points are independently controllable. The advantage of this embodiment is that while machining is being performed at one of the clamping points, loading and unloading may be carried out at another clamping point.

A clamping point shield is advantageously situated in the machining chamber, the clamping point shield being fixedly mounted on a machine table, on the robot, or on the machining spindle. An arrangement which is connected to the machine table and which is able to track the machining spindle may also be provided as the clamping point shield. The clamping point shield provides protection from auxiliary machining materials (media such as oil or emulsion) as well as cutting chips from the machining process. Furthermore, less cleaning of the clamping points is necessary due to the clamping point shield. Flushing elements such as nozzles are advantageously situated in the clamping point shield. These flushing elements may be used to clean the clamping points to be loaded and unloaded, using clean media such as purified emulsion or blown air.

In one refinement of the invention, the robot is situated on the machine table or is directly or indirectly connected thereto. In the present and following discussions, the term “indirectly” means that the robot is connected to the machine table via an intermediate element; correspondingly, the term “directly” means that the robot is connected to the machine table directly, i.e., without an intermediate element. The movement of the robot holder is thus the same as that of the machine table. Therefore, only the movement of the robot holder, and not of the overall robot, is the same as that of the machine table, since the axes of the robot are able to move relative to its robot holder, for example for loading and unloading the clamping points.

One refinement of the invention provides for mounting the robot on a cradle plate, or on machine elements that are fixed in position with respect to the cradle plate. The robot may be directly or indirectly connected to the cradle plate. The movement of the robot holder is thus the same as that of the cradle plate. Therefore, only the movement of the robot holder, and not of the overall robot, is the same as that of the cradle plate, since the axes of the robot are able to move relative to its robot holder, for example for loading and unloading the clamping points.

According to one preferred embodiment of the invention, the robot has a multi-arm design. In a multi-arm robot, each arm can carry out a task independently of another arm, thus advantageously resulting in a shorter machining time.

It is advantageous that the clamping point shield is holdable in a shielding position by at least one robot arm, and the loading and unloading of the clamping points is carried out by at least one further robot arm.

In one refinement of the invention, a robot shield is situated in the machining chamber. The robot shield protects the robot from auxiliary machining materials, cutting chips, and other soiling.

According to one advantageous embodiment of the invention, the machine table is movable at least along a first direction and a second direction, the first direction and the second direction preferably being substantially perpendicular to one another. A machine table that is movable in this way facilitates the loading and unloading of the single-station machining unit, compared to machines in which the machine table also undergoes motions about the Z axis. For table movements in a plane perpendicular to the machining spindle (XY plane), the control may allow intervention during drilling cycles, for example, since in that case only motions about the Z axis are carried out. If the machine loading and unloading lasts for a longer time than this program segment, the machining temporarily halts.

In one refinement of the invention, the single-station machining unit has an additional axis. Additional axes may be fastened to the machine table or to the machine frame. If the design of the machine permits, the machine table may also be dispensed with, and the additional axis may take on the function of the machine table. The additional axes are then often mounted directly on the machine frame. This additional axis results in a further machining axis which is designed not with the machining spindle, but, rather, with a clamping axis.

The clamping points are preferably mounted so that they are rotatable about the additional axis. Such additional axes are used to allow machining of the workpieces from multiple sides. Rotatably mounted clamping points allow cutting chips to fall by gravity, which makes it easier to protect the clamping points to be loaded and unloaded from soiling.

In one refinement of the invention, the clamping points are situated on cradle plates. By fitting the cradle plate with clamping points from at least one side, but more advantageously from at least two sides, it is possible for loading and unloading to take place on the side opposite from the machining spindle, or at some other suitable angle with respect to the spindle. This results in a clamping point shield due to the cradle plate, and falling of cutting chips by gravity, which makes it easier to protect the clamping points to be loaded and unloaded from soiling.

According to one preferred embodiment of the invention, movements of the robot, of the machine table, and/or of an additional axis are at least partially synchronizable, in particular movable in synchronization with one another. The present invention may thus also be used when the machine table is not stationary, i.e., when the machining axes are moved together with the machine table (single- or multi-axial machining with the machine table). The loading and unloading of the clamping points in concurrent operation time is thus ensured, in that a machine controller relays the corresponding axis movements to the robot, which follows the movement. Thus, there is no relative movement between the robot and the machine table.

In another embodiment of the invention, the robot cell has communication means for controlling the robot, whereby the robot is controllable via the communication means as a function of the control of the clamping points, and/or the clamping points are controllable via the communication means as a function of the control of the robot. The communication means convey axis movements between the clamping points and the robot.

A movement of the robot may advantageously be tracked to a movement of the machine table and/or of the additional axis. In this way, the robot can load and unload the clamping points, even for a nonstationary machine table and/or additional axis.

The device according to the invention is characterized in that it has a robot cell according to the invention and a single-station machining unit, the robot cell and the single-station machining unit preferably having an integral design.

The device preferably has a storage unit. The robot cell chamber is preloaded via known methods such as feed systems, conveyor belts, cartridge systems, and pallet systems. This preloading takes place via storage locations of the storage unit. After machining is completed, these finished machined parts are also stored at the storage locations.

The invention is explained in greater detail with reference to the figures, which show the following:

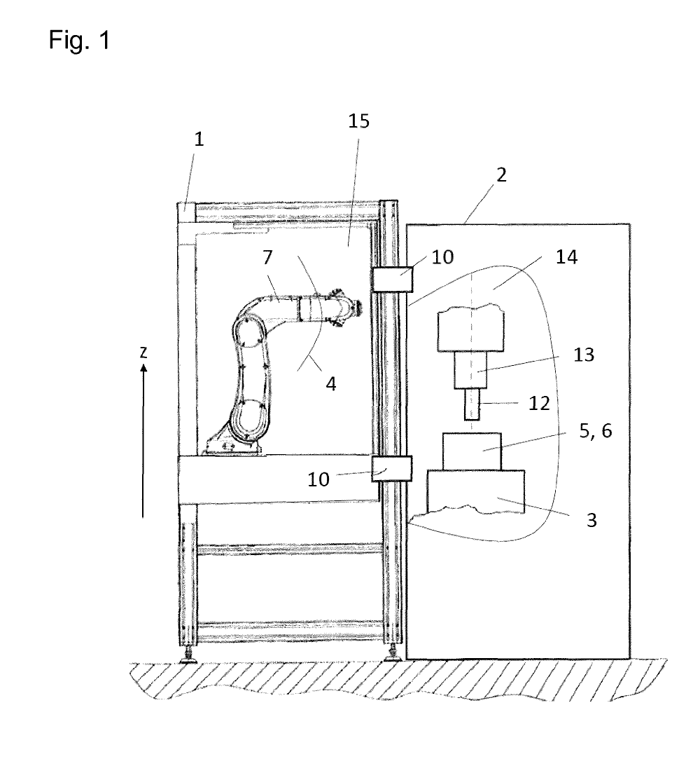

FIG. 1 shows a side view of one exemplary embodiment of a robot cell which is coupled to one exemplary embodiment of a single-station machining unit,

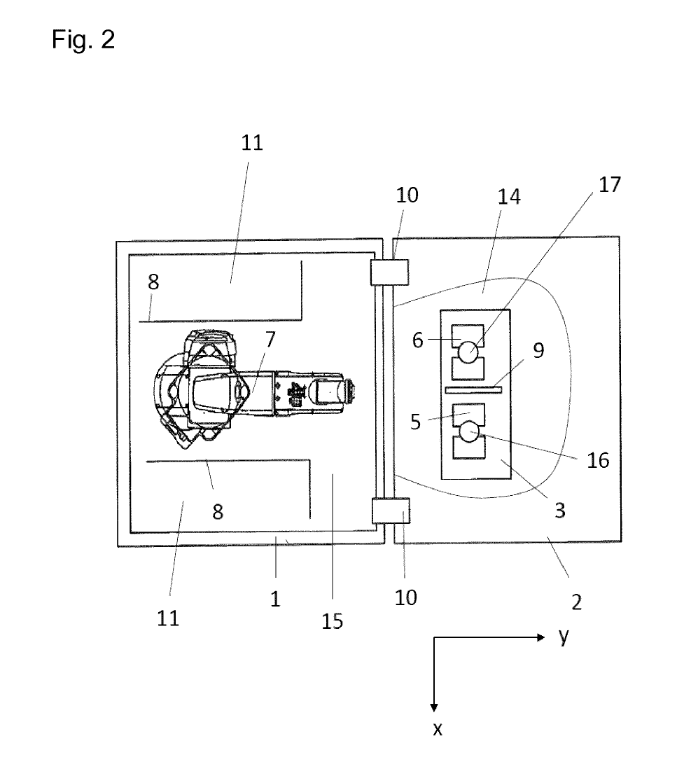

FIG. 2 shows a top view of a robot cell according to FIG. 1,

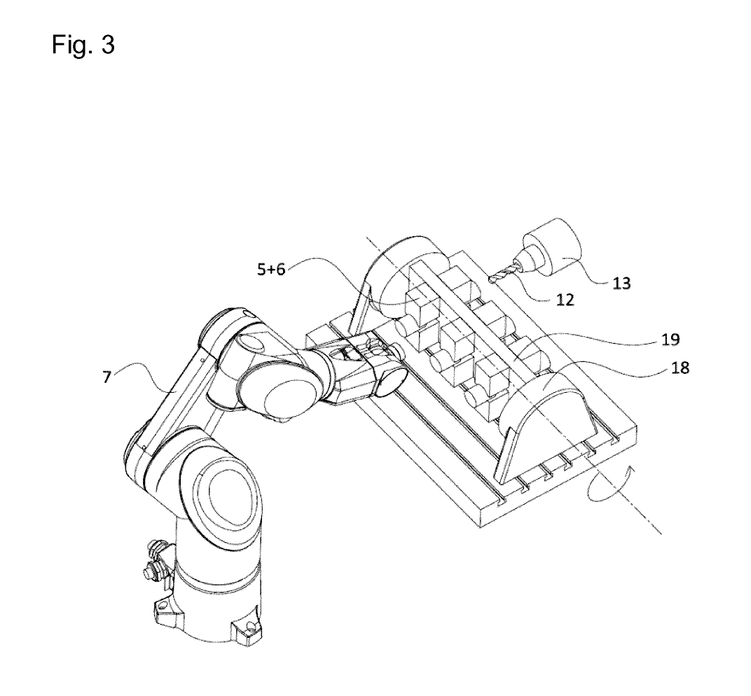

FIG. 3 shows a perspective view of a robot cell according to FIG. 1, with one exemplary embodiment of an additional axis and one exemplary embodiment of a horizontal machining spindle,

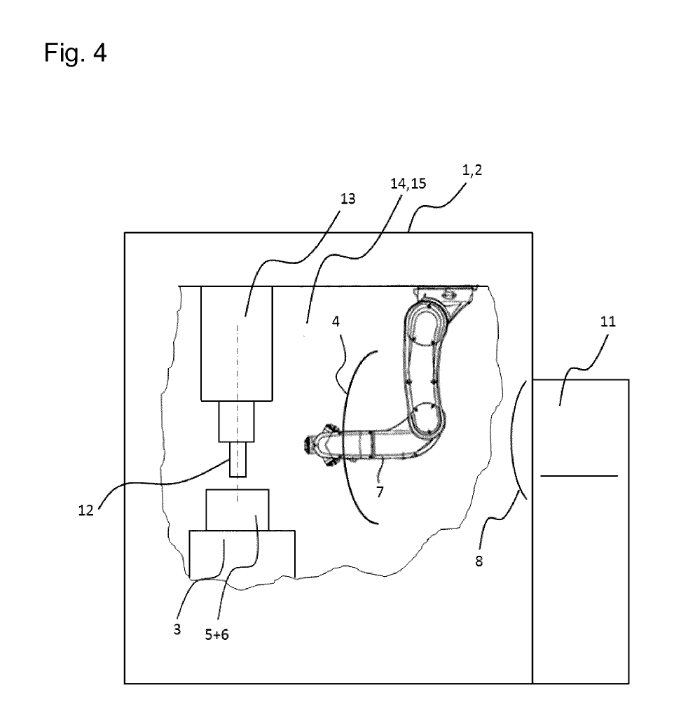

FIG. 4 shows a side view of one exemplary embodiment of an arrangement having an integral design of the robot cell and the single-station machining unit,

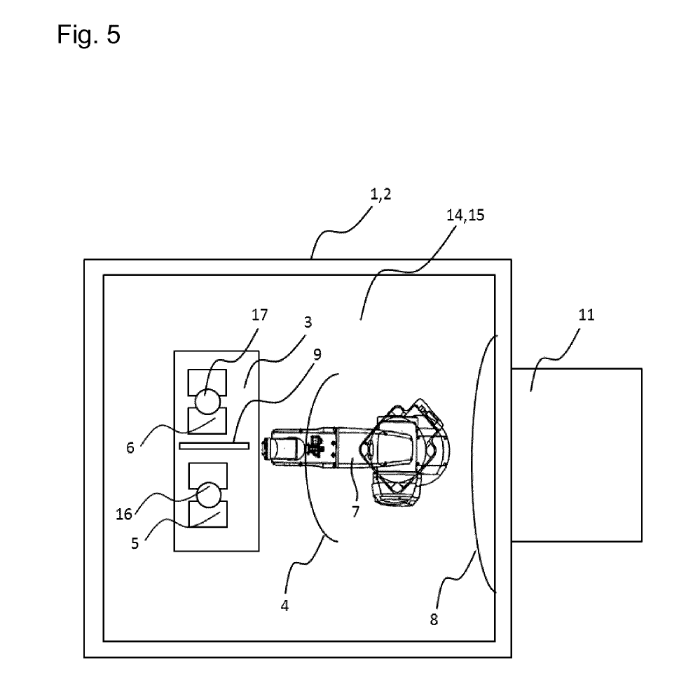

FIG. 5 shows a top view of an arrangement according to FIG. 4,

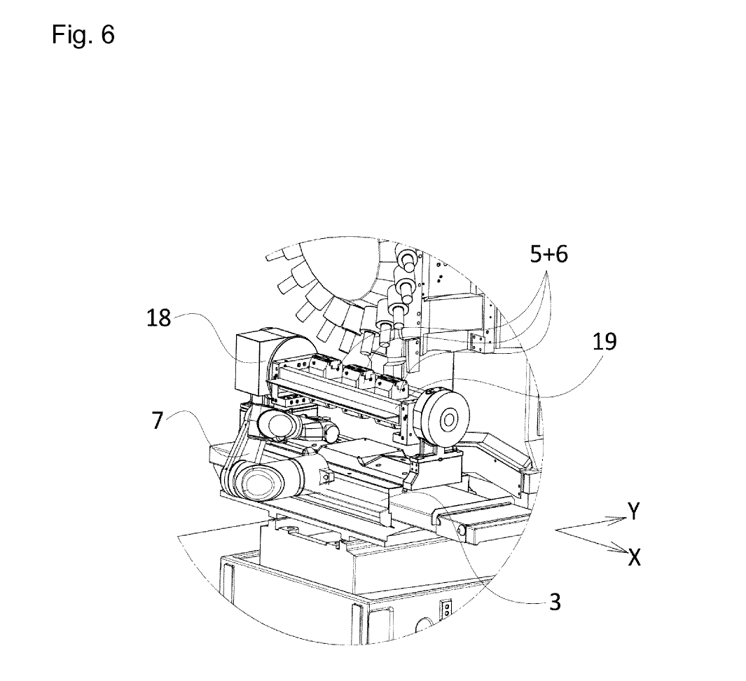

FIG. 6 shows a perspective view of an arrangement having an integral design of one exemplary embodiment of a robot and one exemplary embodiment of a machine table, the robot being situated on or connected to the machine table,

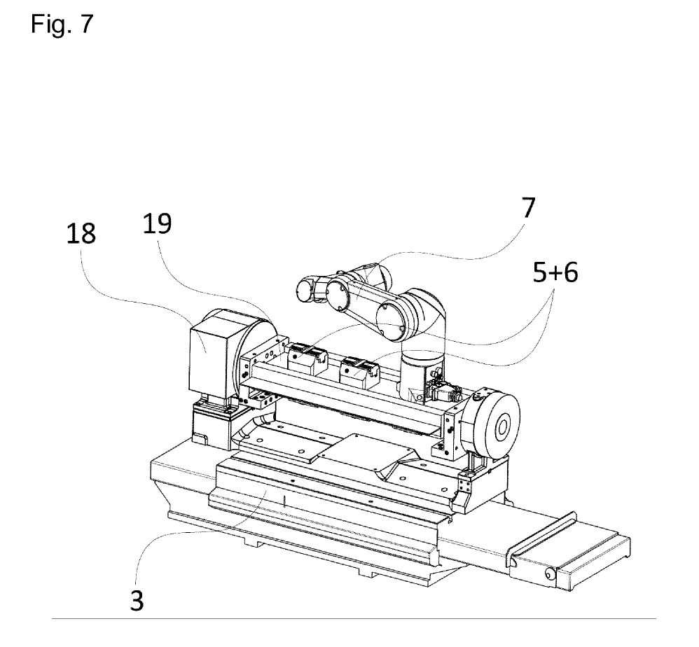

FIG. 7 shows a perspective view of an arrangement having an integral design, with a robot according to FIG. 6 and an additional axis according to FIG. 3, the robot being situated on or connected to the additional axis, and

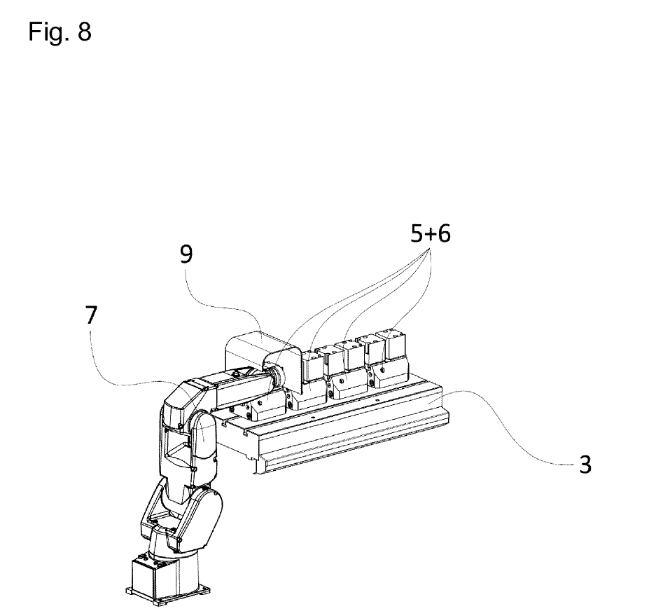

FIG. 8 shows a perspective view of an arrangement with one exemplary embodiment of a clamping point shield on a robot.

FIG. 1 illustrates a side view of one exemplary embodiment of a robot cell 1 together with a single-station machining unit 2.

The robot cell 1 has a robot cell chamber 15 in which a robot 7 is situated. The robot 7 may be operated with appropriate hydraulic or pneumatic drive elements, thus making it possible to avoid electronic problems. The robot 7 is provided with a robot shield 4. The robot shield may be designed as a cover film, as used with foundry robots.

At least two clamping points 5 and 6 and at least one machining spindle 13 of a single-station machining unit 2 are situated in a machine space 14. The single-station machining unit 2 has the machining spindle 13 and a machine tool 12, for example a drill. The clamping points 5, 6 are situated on a machine table 3. The clamping points 5, 6 are reachable by a robot arm. Workpieces 16, 17 may be clamped to the clamping points 5, 6 so that the workpieces can be machined with the machine tool 12 (see FIG. 2). While machining is being performed at one of the clamping points 5, loading and unloading may be carried out at another clamping point 6. These clamping points 5, 6 are then loading and unloading positions. FIG. 2 shows a clamping point shield 9 which is fixedly installed on the table.

The tool holder is inserted into the machining spindle 13, which drives the tool as needed or supports it against torque or other occurring forces (see FIG. 3).

The advantage of the robot cell 1 is the capability for coupling and decoupling. Robot cells are typically designed in such a way that they are formed as closed systems, with an opening facing the loading side of the machine tool, and the working area of the robot reaching out from the actual cell into the machine area. As shown in FIG. 1, the robot cell 1 and the machine space 14 form a shared machining chamber via a coupling site seal 10 of a coupling site. This coupling results in a combination, i.e., no separation, of the machine space 14 and the robot cell chamber 15.

Robot cells may include supply or storage stations for workpieces 16, 17 or workpiece carriers. FIG. 2 shows storage locations 11 situated at the side of the robot 7. Storage location shields 8 protect the storage locations 11 from soiling due to entering media.

Single-station machining units 2 are preferably used when the units are equipped with a stationary work table. The machining spindle 13 is then moved together with other elements in the various axes X, Y, Z. Concurrent loading or unloading of further clamping points may be ensured by the stationary table, even during machining of a workpiece in multiple axes.

The robot cell 1 may also be used when the machine table 3 is not stationary, i.e., when machining axes X, Y are moved together with the machine table 3 (single- or multi-axial machining with the machine table). The loading and unloading of the clamping points 5, 6 in concurrent operation time is ensured in that a machine controller enables the loading and unloading for appropriate program segments, without interfering movements.

FIG. 3 shows an additional axis 18. On this additional axis 18, the workpieces 16, 17 are clamped in the clamping points 5, 6 on a cradle plate 19. A very large number of clamping points 5, 6 may be mounted on this additional axis 18. By fitting this additional axis 18 or the cradle plate 19 with clamping points 5, 6 from at least one side, but more advantageously from at least two sides, as illustrated in FIG. 3, it is possible for loading and unloading to take place on the side opposite from the machining spindle 13, or at some other suitable angle with respect to the spindle. This results in a clamping point shield due to the cradle plate 19, and falling of cutting chips by gravity, which makes it easier to protect the clamping points 5, 6 from soiling.

With the additional axis 18, the robot cell 1 may be used even when the machine table 3 is not stationary, i.e., when machining axes are moved together with the machine table 3 (single- or multi-axial machining with the machine table). The loading and unloading of the clamping points 5, 6 in concurrent operation time is thus ensured, in that the machine controller relays the corresponding axis movements of the machine table 3 and the additional axis 18 to the robot 7, which partially follows the movement. Of the adjusted positions, the robot controller makes use only of the insertion and removal points, and moves toward these.

To keep from having to follow the possibly complex movements which the machine table 3 and the additional axis 18 carry out due to the machining program, one or more axes of the robot 7 may be switched into an elasticity mode (or resiliency mode). This mode imparts a suspension function to one or more axes. With this functionality, the robot together with the grasped part is pulled or pushed to follow the movements of the machine table 3 and the additional axis 18. There is no need to program complex movements, and a synchronization function of the robot movements with the movements of the machine table 3 and of the additional axis 18 is not necessary.

FIGS. 4 and 5 show an integral design of the robot cell 1 and the single-station machining unit 2. In such an arrangement, the robot cell 1 and the single-station machining unit 2 have an integral design.

FIG. 6 shows a design of the robot 7 and the single-station machining unit 2 in which the robot 7 is fastened to the machine table 3. The relative movements between the robot 7 or its base holder and the clamping points are thus eliminated. This results in much simpler programming, since the synchronization or the flexibility switching of the robot is dispensed with. The robot base holder is therefore mentioned, since the robot 7 is still able to undergo relative movements with its axes, and the eliminated relative movement concerns only a stationary robot 7 or the base holder of a robot 7 moving in various axes.

With such a design according to FIG. 6, a robot 7 is described which is connected to the machine table 3 or the machining spindle 13. Thus, as described above, there is no movement of the robot base holder relative to the clamping points 5, 6. In order for the robot 7 to now pick up workpieces for machining or to deposit them at a storage location 11 after machining is complete, for a stationary table there is no need to take special measures. There are various options for a moving table. Firstly, a short machine stoppage may be utilized for the robot 11 [sic; 7] to pick up and deposit workpieces at the storage location 11, for example when drilling motions are carried out strictly in the Z direction and no X and Y movements are carried out. Secondly, the robot movements may be synchronized with the relative movement between the robot 7 and the storage location 11. Thirdly, the robot 7 may track the movements of the storage location 11.

FIG. 7 shows an integral design of the robot 7 and the single-station machining unit 2, the robot 7 being situated on the additional axis 18 or connected thereto. Thus, the robot 7 is connected not directly, but instead, indirectly to the machine table 3, i.e., via an additional element. This design may result in a compact construction.

FIG. 8 shows a perspective view of an arrangement of a robot 7 and the machine table 3, with the clamping point shield 9 situated on the robot 7. Such an arrangement of the clamping point shield 9 may be used for improved protection of the robot 7 from auxiliary machining materials (media such as oil or emulsion) and cutting chips from the machining process.

### LIST OF REFERENCE NUMERALS

1 Robot cell
2 Single-station machining unit
3 Machine table
4 Robot shield
5 Clamping point
6 Clamping point
7 Robot
8 Storage location shield
9 Clamping point shield
10 Coupling site seal
11 Storage location
12 Machine tool
13 Machining spindle
14 Machine space
15 Robot cell chamber
16 Workpiece
17 Workpiece
18 Additional axis
19 Cradle plate

1. A cell comprising:
a robot cell chamber for loading and unloading single-station machining units;
a machine space;
a robot located in the robot cell chamber;
clamping points for receiving workpieces in the machine space;
a machining spindle of a single-station machining unit located in the machine space;
wherein the clamping points can be reached by the robot,
wherein the robot cell chamber is coupleable to the machine space in such a way that a machining chamber is formed in the coupled state of the robot cell chamber and the machine space.

2. The robot cell according to claim 1,
wherein the robot cell is detachably coupleable to the single-station machining unit.

3. The robot cell according to claim 1,
further comprising a coupling site that has a coupling site seal between the robot cell chamber and the machine space on the single-station machining unit.

4. The robot cell according to claim 1,
wherein the single-station machining unit is loadable and unloadable by the robot in concurrent operation time, preferably in an automated manner.

5. The robot cell according to claim 1,
wherein the clamping points for receiving the workpiece in the machine space are reachable by the robot when the machining spindle is idle and running.

6. The robot cell according to claim 1,
wherein the robot cell has means for controlling the clamping points.

7. The robot cell according to claim 6,
wherein the clamping points are independently controllable.

8. The robot cell according to claim 1,
further comprising a clamping point shield located in the machining chamber and fixedly mounted on a machine table, on the robot, or on the machining spindle.

9. The robot cell according to according to claim 1,
wherein the robot is directly or indirectly connected to a machine table.

10. The robot cell according to claim 1,
wherein the robot is directly or indirectly connected to a cradle plate (19).

11. The robot cell according to claim 1,
wherein the robot comprises multiple arms.

12. The robot cell according to claim 8,
wherein the clamping point shield is holdable in a shielding position by the robot, and the loading and unloading of the clamping points is carried out by an additional robot.

13. The robot cell according to claim 1,
wherein a robot shield located in the machining chamber.

14. The robot cell according to claim 1,
wherein the machine table is movable at least along a first direction and a second direction, the first direction and the second direction being substantially perpendicular to one another.

15. The robot cell according to claim 1,
wherein the single-station machining unit has an additional axis.

16. The robot cell according to claim 15,
wherein the clamping points are mounted so that they are rotatable about the additional axis.

17. The robot cell according to claim 15,
wherein the clamping points are arranged on cradle plates.

18. The robot cell according to claim 1,
wherein movements of at least two of the robot, the machine table, and additional axis are at least partially synchronizable.

19. The robot cell according to according to claim 1,
wherein the robot cell controls the robot as a function of the control of the clamping points.

20. The robot cell according to claim 18,
wherein a movement of the robot may be tracked to a movement of the machine table, the additional axis, or both.

21-22. (canceled)
